(19) United States
(12) Patent Application Publication
(10) Pub. No.: US 2019/0375136 A1
(43) Pub. Date: Dec. 12, 2019

(54) CASCADE ASSEMBLY FOR A JET ENGINE THRUST REVERSER

(71) Applicant: The Boeing Company, Chicago, IL (US)

(72) Inventors: Chen Chuck, Mercer Island, WA (US); Tunde Abiodun Olaniyan, Bothell, WA (US); Zachariah B. Vandemark, Snohomish, WA (US); Naimishkumar B. Harpal, Everett, WA (US); David J. Barene, Arlington, WA (US)

(21) Appl. No.: 16/003,842

(22) Filed: Jun. 8, 2018

(51) Int. Cl. B29C 43/00; B29C 33/48; F02K 1/62; B29C 43/14; F02K 1/76

(52) U.S. Cl. CPC B29C 43/003; B29C 33/485; B29C 2043/3668; B29C 43/14; F02K 1/76; F02K 1/62

(57) ABSTRACT

A cascade assembly for a jet engine thrust reverser comprising an inflow cascade, an outflow cascade, and fasteners. The inflow cascade has a plurality of inflow vanes, a plurality of inflow strongbacks, and a front inflow flange. The outflow cascade has a plurality of outflow vanes, a plurality of outflow strongbacks, and a front outflow flange, wherein each of the plurality of outflow strongbacks are parallel to each other. The fasteners extend through the front inflow flange and the front outflow flange.

### BACKGROUND INFORMATION

### 1. Field

The present disclosure relates generally to aircraft and, more specifically, to aircraft having jet engines. Yet more specifically, the present disclosure relates to a cascade assembly for a jet engine thrust reverser and methods for forming the cascade assembly.

### 2. Background

Airplanes with jet engines are often equipped with thrust reversers that increase drag on the airplane during landings, thereby reducing the speed of the aircraft. A thrust reverser increases drag by effectively reversing the flow of exhaust gases through the jet engine. In one type of thrust reverse, referred to as a cascade-type, a transcowl on the jet engine nacelle translates rearwardly to expose a cascade formed by multiple open grid panels. Closing of a blocker door causes a bypass portion of the airflow through the engine to be diverted through a series of circumferentially arranged cascade vanes in the grid panels which are oriented to redirect the airflow forwardly and thereby produce reverse thrust.

The fabrication of cascade grid panels is time consuming, labor intensive, and therefore expensive. Current cascade grid panels are fabricated using fiber reinforced thermoset resins which require many processing steps and specialized equipment. For example, use of thermosets require thawing of prepreg, pre-curing of strongbacks, hand layup of the individual vanes, compression molding to co-cure the strongbacks to the vanes, and post curing.

Therefore, it would be desirable to have a method and apparatus that take into account at least some of the issues discussed above, as well as other possible issues. For example, it would be desirable to create a cascade for a jet engine thrust reverser that is simple in construction and is less expensive to produce. It would also be desirable to have a low cost method of fabricating the cascade that reduces touch labor and requires fewer processing steps as well as less processing equipment.

### SUMMARY

An illustrative example of the present disclosure provides a cascade assembly for a jet engine thrust reverser comprising an inflow cascade, an outflow cascade, and fasteners. The inflow cascade has a plurality of inflow vanes, a plurality of inflow strongbacks, and a front inflow flange. The outflow cascade has a plurality of outflow vanes, a plurality of outflow strongbacks, and a front outflow flange, wherein each of the outflow strongbacks are parallel to each other. The fasteners extend through the front inflow flange and the front outflow flange.

Another illustrative example of the present disclosure provides a method. A cascade assembly having an inflow cascade and an outflow cascade is positioned relative to a jet engine such that the inflow cascade is closer than the outflow cascade to an axis running through the jet engine, wherein the axis runs from an inlet of the jet engine to an exhaust nozzle of the jet engine. Fasteners are installed through a front inflow flange of the inflow cascade and through a front outflow flange of the outflow cascade to fasten the cascade assembly to the jet engine.

Yet another illustrative example of the present disclosure provides a method. An inflow cascade having a plurality of inflow vanes and a plurality of inflow strongbacks is joined to an outflow cascade having a plurality of outflow vanes and a plurality of outflow strongbacks to form a cascade assembly configured to redirect exhaust flow, wherein each of the plurality of outflow strongbacks are parallel to each other, and wherein joining the inflow cascade and the outflow cascade comprises overlapping respective flanges of the inflow cascade and the outflow cascade.

The features and functions can be achieved independently in various examples of the present disclosure or may be combined in yet other examples in which further details can be seen with reference to the following description and drawings.

### BRIEF DESCRIPTION OF THE DRAWINGS

The novel features believed characteristic of the illustrative examples are set forth in the appended claims. The illustrative examples, however, as well as a preferred mode of use, further objectives and features thereof, will best be understood by reference to the following detailed description of an illustrative example of the present disclosure when read in conjunction with the accompanying drawings, wherein:

FIG. 1 is an illustration of a block diagram of a manufacturing environment in which a cascade assembly for a jet engine thrust reverser is manufactured in accordance with an illustrative example;

FIG. 2 is an illustration of a side elevational view of an airplane jet engine, a transcowl having shifted rearwardly to expose a cascade assembly for a jet engine thrust reverser in accordance with an illustrative example;

FIG. 3 is an illustration of a perspective view of the aft end of an airplane jet engine, a transcowl having shifted rearwardly to expose a cascade assembly for a jet engine thrust reverser in accordance with an illustrative example;

FIG. 4 is an illustration of a longitudinal sectional view of a portion of an airplane jet engine, illustrating airflow through the cascade assembly for the thrust reverser in accordance with an illustrative example;

FIG. 5 is an illustration of a sectional view of a cascade assembly in an airplane jet engine in accordance with an illustrative example;

FIG. 6 is an illustration of an exploded view of a cascade assembly in accordance with an illustrative example;

FIG. 7 is an illustration of a front cross-sectional view of a cascade assembly in accordance with an illustrative example;

FIG. 8 is an illustration of a side cross-sectional view of a cascade assembly in accordance with an illustrative example;

FIG. 9 is an illustration of a side cross-sectional view of an inflow compression molding tool and an inflow cascade in accordance with an illustrative example;

FIG. 10 is an illustration of a side cross-sectional view of an outflow compression molding tool and an outflow cascade in accordance with an illustrative example;

FIG. 11 is an illustration of an isometric view of an inflow compression molding tool in accordance with an illustrative example;

FIG. 12 is an illustration of a flowchart of a method for using a cascade assembly in accordance with an illustrative example;

FIGS. 13A-13B are an illustration of a flowchart of a method for forming a cascade assembly in accordance with an illustrative example;

FIG. 14 is an illustration of an aircraft manufacturing and service method in the form of a block diagram in accordance with an illustrative example; and

FIG. 15 is an illustration of an aircraft in the form of a block diagram in which an illustrative example may be implemented.

### DETAILED DESCRIPTION

The illustrative examples recognize and take into account one or more different considerations. For example, the illustrative examples recognize and take into account that it would be desirable to compression mold thermoplastic cascades. The illustrative examples recognize and take into account that compression molding traditional cascade designs may use mold designs that are undesirable complicated with many parts. The illustrative examples recognize and take into account that one way of compression molding thermoplastic material into a conventional one piece cascade would utilize molds with hundreds of parts. The illustrative examples recognize and take into account that using a mold with hundreds of parts uses an undesirable amount of labor to organize and assemble the mold parts. The illustrative examples recognize and take into account that the additional time and components for compression molding traditional cascade designs undesirably increases the cost of the compression molding process.

The illustrative examples recognize and take into account that in conventional cascades the vanes, which provide the forward turning, and the strongbacks, which provide the side turning, have both curved and straight sections. The illustrative examples recognize and take into account that the curved sections are on the inner side and the straight sections are on the outer side. The illustrative examples recognize and take into account that the geometry of traditional cascades makes removing a simple mold insert from the passages created by the vanes and strongbacks of the cascade impossible or undesirably difficult.

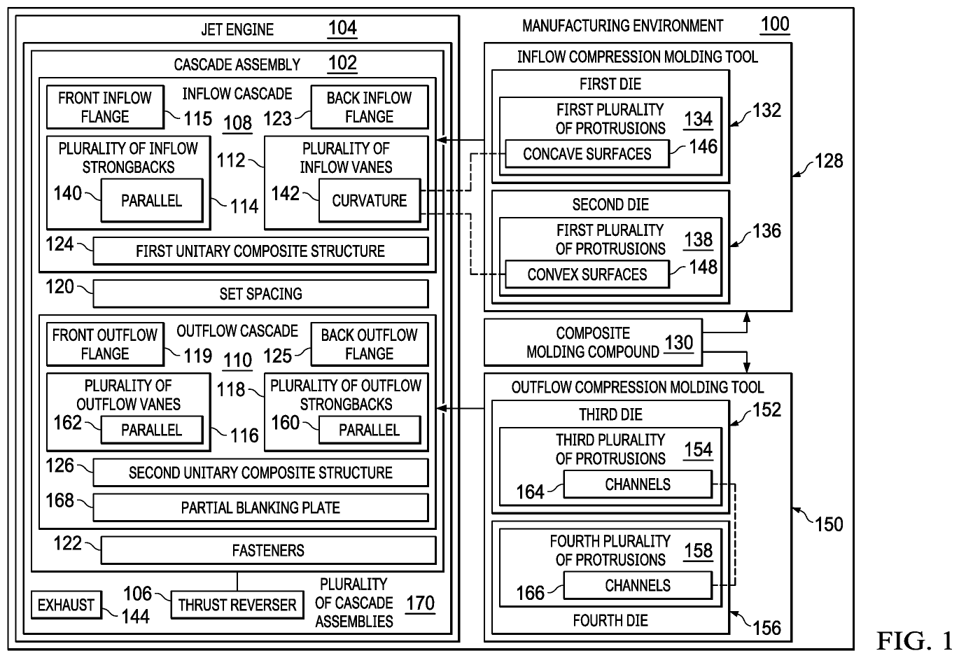

Turning now to FIG. 1, an illustration of a block diagram of a manufacturing environment in which a cascade assembly for a jet engine thrust reverser is manufactured is depicted in accordance with an illustrative example. Manufacturing environment 100 is an environment in which cascade assembly 102 for jet engine 104 thrust reverser 106 is manufactured. Cascade assembly 102 comprises inflow cascade 108 and outflow cascade 110. Inflow cascade 108 has plurality of inflow vanes 112, plurality of inflow strongbacks 114, and front inflow flange 115. Outflow cascade 110 has plurality of outflow vanes 116, plurality of outflow strongbacks 118, and front outflow flange 119. In some illustrative examples, each of plurality of outflow vanes 116 are parallel to each other. Each of plurality of outflow strongbacks 118 are parallel to each other.

In some illustrative examples, plurality of inflow vanes 112 and plurality of outflow vanes 116 may be treated as a set of vanes of cascade assembly 102. In these illustrative examples, the set of vanes has a curved section. The division of the set of vanes into plurality of inflow vanes 112 and plurality of outflow vanes 116 is positioned to reduce complexity in mold design. In some illustrative examples, the division of the set of vanes into plurality of inflow vanes 112 and plurality of outflow vanes 116 is to form a straight section and a curved section.

In some illustrative examples, plurality of inflow strongbacks 114 and plurality of outflow strongbacks 118 may be treated as a set of strongbacks of cascade assembly 102. In these illustrative examples, the set of strongbacks has a curved section. In some illustrative examples, the division of the set of strongbacks into plurality of inflow strongbacks 114 and plurality of outflow strongbacks 118 is positioned to reduce complexity in mold design. In some illustrative examples, the division of the set of strongbacks into plurality of inflow strongbacks 114 and plurality of outflow strongbacks 118 is to form a straight section and a curved section.

In some illustrative examples, the set of vanes and the set of strongbacks have common curve locations. In these illustrative examples, the location of the split between the curved and straight sections is common for the vanes and the strongbacks and will reduce complexity in mold design.

In some illustrative examples, inflow cascade 108 and outflow cascade 110 are separated by set spacing 120. In some illustrative examples, set spacing 120 is up to one inch. Set spacing 120 within cascade assembly 102 is maintained using any desirable structures.

In some illustrative examples, set spacing 120 reduces fatigue in cascade assembly 102. In some illustrative examples, fatigue in inflow cascade 108 and outflow cascade 110 is lower when set spacing 120 is present.

In some illustrative examples, set spacing 120 between inflow cascade 108 and outflow cascade 110 is maintained by fasteners 122 joining inflow cascade 108 and outflow cascade 110. In some illustrative examples, fasteners 122 take the form of bolts extending through inflow cascade 108 and outflow cascade 110.

Fasteners 122 join inflow cascade 108 and outflow cascade 110 in any desirable fashion. In some illustrative examples, fasteners 122 extend through front inflow flange 115 and front outflow flange 119. In some illustrative examples, front inflow flange 115 and front outflow flange 119 are described as overlapping flanges. In some illustrative examples, front inflow flange 115 and front outflow flange 119. are each substantially flat and substantially parallel to each other.

In some illustrative examples, joining inflow cascade 108 and outflow cascade 110 comprises overlapping respective flanges of inflow cascade 108 and outflow cascade 110. In some illustrative examples, joining inflow cascade 108 and outflow cascade 110 comprises overlapping front inflow flange 115 of inflow cascade 108 and front outflow flange 119 of outflow cascade 110. After overlapping front inflow flange 115 of inflow cascade 108 and front outflow flange 119 of outflow cascade 110, fasteners 122 are sent through front inflow flange 115 and front outflow flange 119.

In some illustrative examples, inflow cascade 108 has back inflow flange 123. In some illustrative examples, outflow cascade 110 has back outflow flange 125. In some illustrative examples, cascade assembly 102 comprises additional fasteners (not depicted) joining inflow cascade 108 and outflow cascade 110 by extending through back inflow flange 123 and back outflow flange 125. In some illustrative examples, back inflow flange 123 and back outflow flange 125 are perpendicular to front inflow flange 115 and front outflow flange 119.

In some illustrative examples, joining inflow cascade 108 and outflow cascade 110 comprises overlapping respective flanges of inflow cascade 108 and outflow cascade 110. In some illustrative examples, joining inflow cascade 108 and outflow cascade 110 comprises overlapping back inflow flange 123 of inflow cascade 108 and back outflow flange 125 of outflow cascade 110. After overlapping back inflow flange 123 of inflow cascade 108 and back outflow flange 125 of outflow cascade 110, fasteners are sent through back inflow flange 123 and back outflow flange 125.

In some illustrative examples, inflow cascade 108 is first unitary composite structure 124 and outflow cascade 110 is second unitary composite structure 126. In some illustrative examples, first unitary composite structure 124 is formed using inflow compression molding tool 128.

To form first unitary composite structure 124, composite molding compound 130 is introduced into inflow compression molding tool 128. Inflow compression molding tool 128 has first die 132 with first plurality of protrusions 134 and second die 136 with second plurality of protrusions 138. Composite molding compound 130 is compressed between first die 132 and second die 136 to form inflow cascade 108 with plurality of inflow strongbacks 114 and plurality of inflow vanes 112.

Plurality of inflow strongbacks 114 are parallel 140 to each other to allow for removal of first plurality of protrusions 134 and second plurality of protrusions 138 from inflow cascade 108. Plurality of inflow vanes 112 have curvature 142 to direct exhaust 144 in operation. Curvature 142 is designed to allow for removal of first plurality of protrusions 134 and second plurality of protrusions 138 from inflow cascade 108.

Inflow cascade 108 is designed to be formed using only two dies: first die 132 and second die 136. Curvature 142 of plurality of inflow vanes 112 is formed using concave surfaces 146 of first plurality of protrusions 134 and convex surfaces 148 of second plurality of protrusions 138. Curvature 142 of a respective inflow vane of plurality of inflow vanes 112 is formed between a respective concave surface of concave surfaces 146 and a respective convex surface of convex surfaces 148.

In some illustrative examples, second unitary composite structure 126 is formed using outflow compression molding tool 150. To form second unitary composite structure 126, composite molding compound 130 is introduced into outflow compression molding tool 150. Outflow compression molding tool 150 has third die 152 with third plurality of protrusions 154 and fourth die 156 with fourth plurality of protrusions 158. Composite molding compound 130 is compressed between third die 152 and fourth die 156 to form outflow cascade 110 with plurality of outflow strongbacks 118 and plurality of outflow vanes 116.

Plurality of outflow strongbacks 118 are parallel 160 to each other to allow for removal of third plurality of protrusions 154 and fourth plurality of protrusions 158 from outflow cascade 110. In some illustrative examples, plurality of outflow strongbacks 118 are angled to provide side turning. Plurality of outflow vanes 116 are parallel 162 to allow for removal of third plurality of protrusions 154 and fourth plurality of protrusions 158 from outflow cascade 110. In some illustrative examples, plurality of outflow vanes 116 are angled to provide forward turning.

Outflow cascade 110 is designed to be formed using only two dies: third die 152 and fourth die 156. Curvature 142 of plurality of inflow vanes 112 is formed using concave surfaces 146 of first plurality of protrusions 134 and convex surfaces 148 of second plurality of protrusions 138. Curvature 142 of a respective inflow vane of plurality of inflow vanes 112 is formed between a respective concave surface of concave surfaces 146 and a respective convex surface of convex surfaces 148.

To form plurality of outflow vanes 116, composite molding compound 130 is formed using channels 164 between third plurality of protrusions 154 and channels 166 between fourth plurality of protrusions 158. For example, each outflow vane of plurality of outflow vanes 116 is formed by a channel of channels 164 and a channel of channels 166.

In some illustrative examples, outflow cascade 110 of cascade assembly 102 includes partial blanking plate 168. Partial blanking plate 168 is a portion of outflow cascade 110 without plurality of outflow vanes 116.

In some illustrative examples, it is desirable to partially block a flow through cascade assembly 102. For example, it may be desirable to partially block a flow through cascade assembly 102 to avoid aerodynamic impingement with surrounding structural elements. In some illustrative examples, some of the last vane flow packages at the aft end of cascade assembly 102 are blanked by inserting a plate or a series of plates.

Cascade assembly 102 is one of plurality of cascade assemblies 170 for jet engine 104. In some illustrative examples, each of plurality of cascade assemblies 170 is formed using compression molding. In some illustrative examples, at least one of plurality of cascade assemblies 170 other than cascade assembly 102 is formed using compression molding.

As used herein, the phrase “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

This example also may include item A, item B, and item C, or item B and item C. Of course, any combination of these items may be present. In other examples, “at least one of” may be, for example, without limitation, two of item A, one of item B, and ten of item C; four of item B and seven of item C; or other suitable combinations.

Each cascade assembly of plurality of cascade assemblies 170 has a respective inflow cascade and a respective outflow cascade. In some illustrative examples, each inflow cascade of plurality of cascade assemblies 170 has a same design as inflow cascade 108 of cascade assembly 102. In these illustrative examples, each cascade assembly of plurality of cascade assemblies 170 has a same inflow cascade design.

In some illustrative examples, each of inflow cascades of plurality of cascade assemblies 170 is formed using inflow compression molding tool 128. In some illustrative examples, each of inflow cascades of plurality of cascade assemblies 170 is formed using a different inflow compression molding tool depending on the angles of the respective inflow strong backs and the curvature of the respective inflow vanes of each inflow cascade. In some illustrative examples, each of outflow cascades of plurality of cascade assemblies 170 is formed using a different outflow compression molding tool depending on the angles of the respective outflow strong backs and the angles of the respective outflow vanes of each outflow cascade.

The illustration of manufacturing environment 100 in FIG. 1 is not meant to imply physical or architectural limitations to the manner in which an illustrative example may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative example.

For example, although not depicted in FIG. 1, mechanical spacers may be placed between inflow cascade 108 and outflow cascade 110 to create and maintain set spacing 120. As another example, although set spacing 120 is present, in other illustrative examples, inflow cascade 108 and outflow cascade 110 are not separated by set spacing 120. In some illustrative examples, inflow cascade 108 is adhered directly to outflow cascade 110.

Although not depicted in FIG. 1, additional fastening mechanisms may be present. As an example, additional fasteners and bosses may be present and spaced throughout cascade assembly 102. Although not depicted in FIG. 1, plates may be attached to sides of both inflow cascade 108 and outflow cascade 110. In some examples, plates may be attached inside vane passageways of inflow cascade 108 and outflow cascade 110.

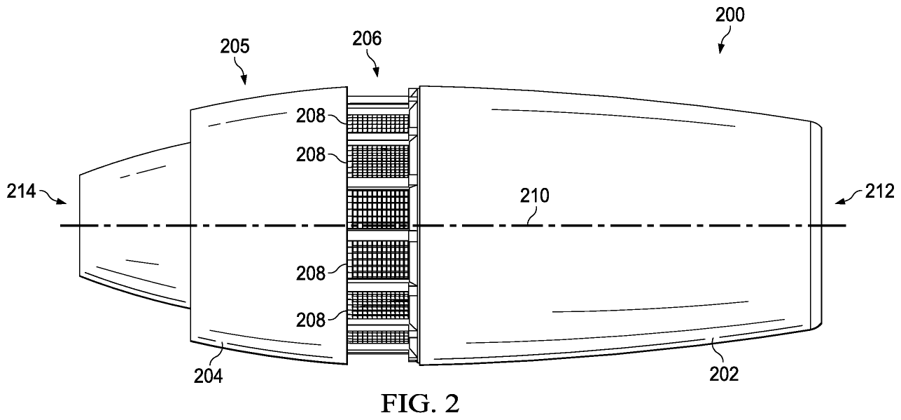

Turning now to FIG. 2, an illustration of a side elevational view of an airplane jet engine, a transcowl having shifted rearwardly to expose a cascade assembly for a jet engine thrust reverser is depicted in accordance with an illustrative example. Jet engine 200 is a physical implementation of jet engine 104 of FIG. 1. Jet engine 200 includes engine nacelle 202 and transcowl 204 that translates rearwardly to open position 205 to expose thrust reverser 206. Thrust reverser 206 includes plurality of cascade assemblies 208. Plurality of cascade assemblies 208 is a physical implementation of plurality of cascade assemblies 170 of FIG. 1. Plurality of cascade assemblies 208 is a plurality of circumferentially arranged, thrust reversing cascade grid panels, sometimes referred to as cascade baskets.

Axis 210 runs from inlet 212 of jet engine 200 to exhaust nozzle 214 of jet engine 200. When a cascade assembly of plurality of cascade assemblies 208 has an inflow cascade and an outflow cascade, the inflow cascade is closer than the outflow cascade to axis 210 running through jet engine 200.

In some illustrative examples, each of plurality of cascade assemblies 208 is different. In some illustrative examples, at least two of plurality of cascade assemblies 208 are the same design. In some illustrative examples, components of plurality of cascade assemblies 208 are the same. For example, each cascade assembly of the plurality of cascade assemblies 208 may have a same inflow cascade design.

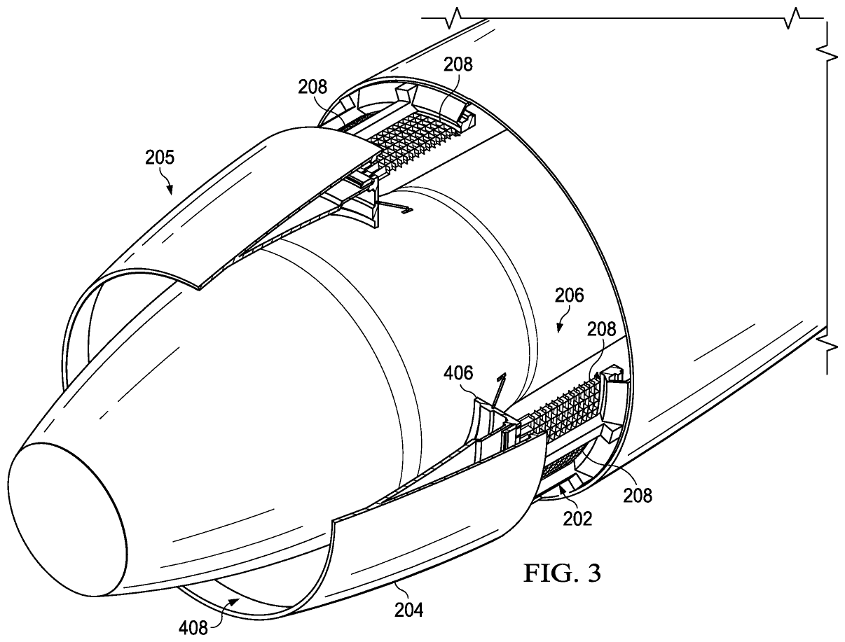

Turning now to FIG. 3, an illustration of a perspective view of the aft end of an airplane jet engine, a transcowl having shifted rearwardly to expose a cascade assembly for a jet engine thrust reverser is depicted in accordance with an illustrative example.

In view 300, transcowl 204 is in open position 205 exposing plurality of cascade assemblies 208. In view 300, portions of plurality of cascade assemblies 208 and portions of jet engine 200 have been cut away.

As depicted, each of plurality of cascade assemblies 208 comprises a respective inflow cascade and a respective outflow cascade. For example, cascade assembly 302 of plurality of cascade assemblies 208 may be a physical implementation of cascade assembly 102 of FIG. 1. Cascade assembly 302 has inflow cascade 304 and outflow cascade 306.

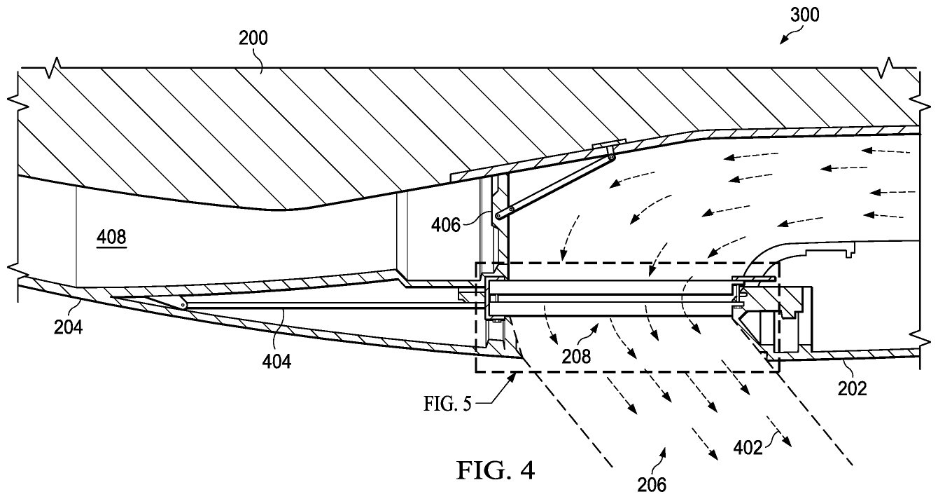

Turning now to FIG. 4, an illustration of a longitudinal sectional view of a portion of an airplane jet engine, illustrating airflow through the cascade assembly for the thrust reverser is depicted in accordance with an illustrative example. View 400 is a cross-sectional view of jet engine 200 with arrows 402 added to depict exhaust.

During normal flying operations, transcowl 204 is in a closed, forward position, joining transcowl 204 with engine nacelle 202, and thereby covering plurality of cascade assemblies 208. During landing, transcowl 204 is moved from its closed position (not depicted) to open position 205 by means of actuator rods 404. In some illustrative examples, open position 205 may also be referred to as a rearwardly extended position.

Opening transcowl 204 exposes plurality of cascade assemblies 208 to the surrounding environment. With transcowl 204 having been shifted to open position 205, thrust reverser 206 is activated by closing circumferentially located blocker doors 406. Closing the blocker doors 406 prevents the bypass exhaust 65 from flowing in its normal direction out of the nozzle 408, forcing the exhaust through plurality of cascade assemblies 208, as shown by the arrows 402. Each of plurality of cascade assemblies 208 includes vanes (not depicted) that direct the flow of the exhaust forward, and optionally radially outward, producing a reversal in the direction of the exhaust flow. This reversal of the exhaust flow results in a reversal of thrust that assists in slowing down the aircraft.

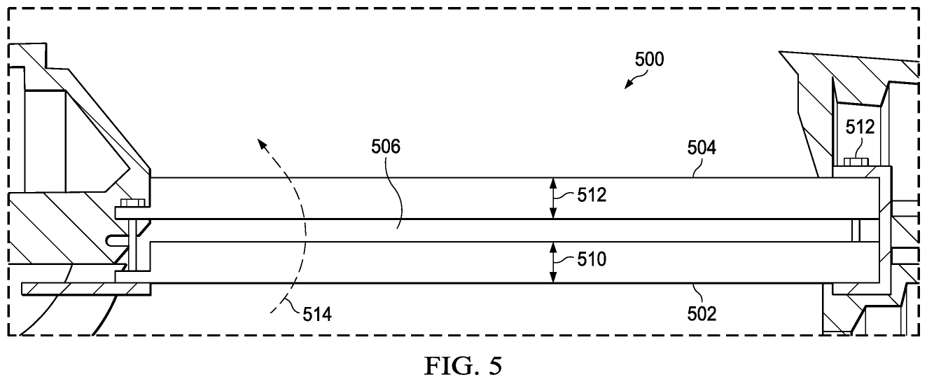

Turning now to FIG. 5, an illustration of a sectional view of a cascade assembly in an airplane jet engine is depicted in accordance with an illustrative example. Cascade assembly 500 is one of plurality of cascade assemblies 208 of FIGS. 2-4. Cascade assembly 500 is a physical implementation of cascade assembly 102 of FIG. 1. Cascade assembly 500 comprises inflow cascade 502 and outflow cascade 504. Inflow cascade 502 is a physical implementation of inflow cascade 108 of FIG. 1. Outflow cascade 504 is a physical implementation of outflow cascade 110 of FIG. 1.

Inflow cascade 502 and outflow cascade 504 are separated by set spacing 506. Set spacing 506 has any desirable value. As depicted, set spacing 506 is less than thickness 508 of inflow cascade 502. As depicted, set spacing 506 is less than thickness 510 of outflow cascade 504. As depicted, set spacing 506 is maintained by fasteners 512 extending through inflow cascade 502 and outflow cascade 504.

In some illustrative examples, exhaust 514 is a turbulent flow through cascade assembly 500. In some illustrative examples, set spacing 506 reduces fatigue in cascade assembly 500. In some illustrative examples, fatigue in inflow cascade 502 and outflow cascade 504 is lower when set spacing 506 is present.

As depicted, exhaust 514 enters inflow cascade 502 and inflow vanes (not depicted) direct exhaust 514 to outflow cascade 504. Exhaust 514 is directed by outflow vanes (not depicted) such that direction of exhaust 514 is substantially reversed.

As depicted, each of inflow cascade 502 and outflow cascade 504 have a respective mounting flange configured to allow cascade assembly 500 to be mounted to jet engine 104 or jet engine 200. Inflow cascade 502 has front inflow flange 516. Outflow cascade 504 has front outflow flange 518. At least one fastener of fasteners 512 extends through front inflow flange 516 and front outflow flange 518 to secure cascade assembly 500 in jet engine 200. In some illustrative examples, respective mounting flanges for each of plurality of cascade assemblies 208 allow the plurality of cascade assemblies 208 to be mounted side-by-side in a circumferential arrangement around engine nacelle 202.

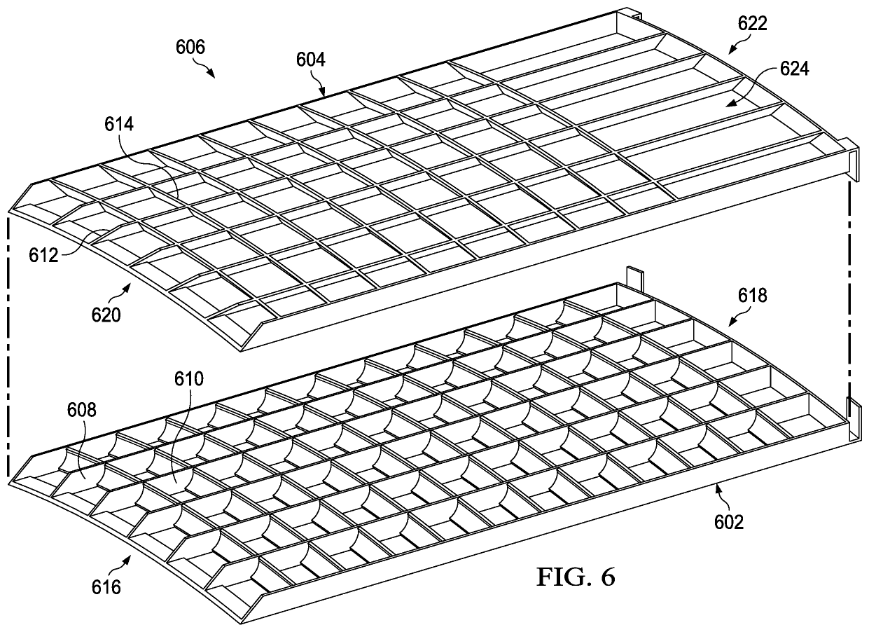

Turning now to FIG. 6, an illustration of an exploded view of a cascade assembly is depicted in accordance with an illustrative example. Cascade assembly 600 is a physical implementation of cascade assembly 102 of FIG. 1. Cascade assembly 600 may be one of plurality of cascade assemblies 208 prior to installation on jet engine 200 of FIGS. 2-4. In some illustrative examples, cascade assembly 600 is the same as cascade assembly 500 of FIG. 5.

Cascade assembly 600 comprises inflow cascade 602 and outflow cascade 604. Inflow cascade 602 is a physical implementation of inflow cascade 108 of FIG. 1. Outflow cascade 604 is a physical implementation of outflow cascade 110 of FIG. 1. In some illustrative examples, cascade assembly 600

In view 606, plurality of inflow vanes 608 and plurality of inflow strongbacks 610 of inflow cascade 602 are visible. In view 606, plurality of outflow vanes 612 and plurality of outflow strongbacks 614 of outflow cascade 604 are visible.

By tailoring the design of plurality of inflow vanes 608 and plurality of inflow strongbacks 610, an inflow compression molding tool having only two opposing dies may be used to form inflow cascade 602. For example, inflow compression molding tool 128 of FIG. 1 may be used to form inflow cascade 602.

By tailoring the design of plurality of outflow vanes 612 and plurality of outflow strongbacks 614, an outflow compression molding tool having only two opposing dies may be used to form outflow cascade 604. For example, outflow compression molding tool 150 of FIG. 1 may be used to form outflow cascade 604.

In view 606 inflow cascade 602 has front inflow flange 616 and back inflow flange 618. As depicted, outflow cascade 604 has front outflow flange 620 and back outflow flange 622.

In some illustrative examples, joining inflow cascade 602 and outflow cascade 604 comprises overlapping front inflow flange 616 and front outflow flange 620. In some illustrative examples, joining inflow cascade 602 and outflow cascade 604 comprises overlapping back inflow flange 618 and back outflow flange 622.

As depicted, outflow cascade 604 also has partial blanking plate 624. Partial blanking plate 624 is a portion of outflow cascade 604 without plurality of outflow vanes 612.

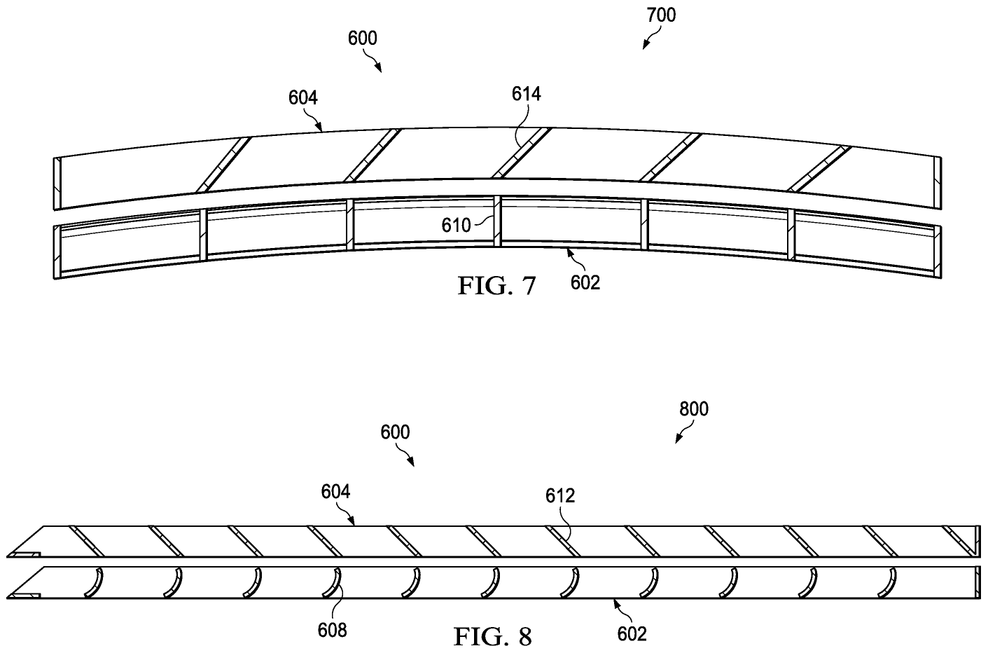

Turning now to FIG. 7, an illustration of a front cross-sectional view of a cascade assembly is depicted in accordance with an illustrative example. View 700 is a front cross-sectional view of cascade assembly 600 after joining together components of cascade assembly 600.

In view 700, inflow strongbacks 610 and outflow strongbacks 614 are visible. As can be seen, inflow strongbacks 610 are each parallel to each other. By inflow strongbacks 610 each being parallel to each other, removal of tooling is simplified for compression molding processes. As depicted, inflow strongbacks 610 are at a zero degree angle.

As can be seen, outflow strongbacks 614 are each parallel to each other. By outflow strongbacks 614 each being parallel to each other, removal of tooling is simplified for compression molding processes. As depicted, outflow strongbacks 614 are at a 45 degree angle. In other illustrative examples, outflow strongbacks 614 may have any desirable angle in the range of +/−50 degrees.

Turning now to FIG. 8, an illustration of a side cross-sectional view of a cascade assembly is depicted in accordance with an illustrative example. View 800 is a side cross-sectional view of cascade assembly 600 after joining together components of cascade assembly 600.

In view 800, plurality of inflow vanes 608 and outflow vanes 612 are visible. As depicted, plurality of inflow vanes 608 are curved. As can be seen, each of plurality of inflow vanes 608 have the same curvature and same orientation. Design of plurality of inflow vanes 608, simplifies removal of tooling for compression molding processes.

As can be seen, plurality of outflow vanes 612 are each parallel to each other. By plurality of outflow vanes 612 each being parallel to each other, removal of tooling is simplified for compression molding processes. As depicted, plurality of outflow vanes 612 are at a −45 degree angle. In other illustrative examples, plurality of outflow vanes 612 may have any desirable angle in the range of +/−60 degrees.

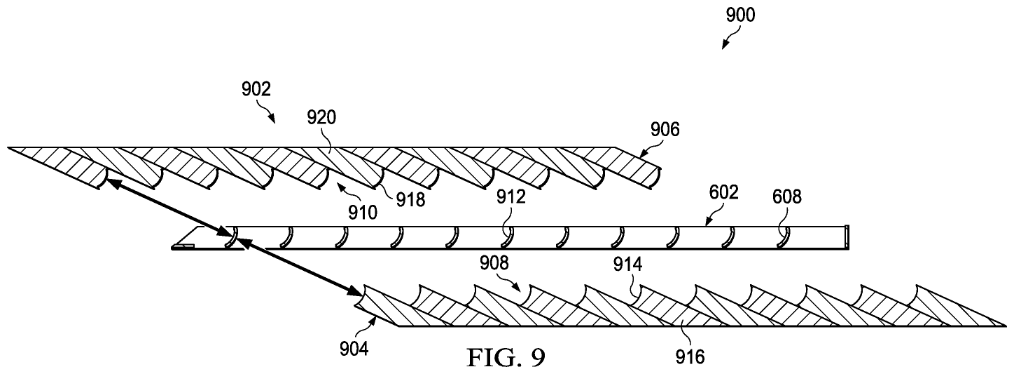

Turning now to FIG. 9, an illustration of a side cross-sectional view of an inflow compression molding tool and an inflow cascade is depicted in accordance with an illustrative example. View 900 is a cross-sectional view of inflow compression molding tool 902 as first die 904 and second die 906 move away from inflow cascade 602. Inflow compression molding tool 902 is a physical implementation of inflow compression molding tool 128 of FIG. 1.

First plurality of protrusions 908 and second plurality of protrusions 910 of inflow compression molding tool 902 form plurality of inflow vanes 608 of inflow cascade 602. As depicted, each inflow vane of plurality of inflow vanes 608 is formed between a surface of a respective protrusion of first plurality of protrusions 908 and a surface of a respective protrusion of second plurality of protrusions 910. For example, inflow vane 912 is formed by concave surface 914 of protrusion 916 of first plurality of protrusions 908 and convex surface 918 of protrusion 920 of second plurality of protrusions 910. Each of plurality of inflow vanes 608 is designed such that first plurality of protrusions 908 and second plurality of protrusions 910 may be easily removed in a single removal process.

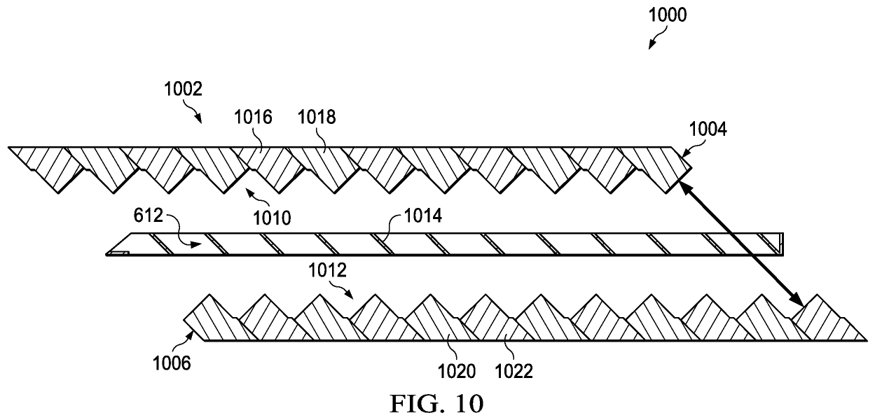

Turning now to FIG. 10, an illustration of a side cross-sectional view of an outflow compression molding tool and an outflow cascade is depicted in accordance with an illustrative example. View 1000 is a cross-sectional view of outflow compression molding tool 1002 as third die 1004 and fourth die 1006 move away from outflow cascade 604. Outflow compression molding tool 1002 is a physical implementation of outflow compression molding tool 150 of FIG. 1.

Third plurality of protrusions 1010 and fourth plurality of protrusions 1012 of outflow compression molding tool 1002 form plurality of outflow vanes 612 of outflow cascade 604. As depicted, each outflow vane of plurality of outflow vanes 612 is formed between two respective protrusions of third plurality of protrusions 1010 and between two respective protrusions of fourth plurality of protrusions 1012. For example, outflow vane 1014 is formed between protrusion 1016 and protrusion 1018 of third plurality of protrusions 1010 and protrusion 1020 and protrusion 1022 of fourth plurality of protrusions 1012.

Each of plurality of outflow vanes 612 of outflow cascade 604 is parallel to each other outflow vane of plurality of outflow vanes 612. By each of plurality of outflow vanes 612 being parallel, third plurality of protrusions 1010 and fourth plurality of protrusions 1012 may be easily removed in a single removal process.

The illustration of cascade assembly 600 and its components in FIGS. 6-10 is not meant to imply physical or architectural limitations to the manner in which an illustrative example may be implemented. For example, the angles of plurality of outflow vanes 612 and outflow strongbacks 614 may have any desirable angles and are not limited to those depicted in FIGS. 6-8.

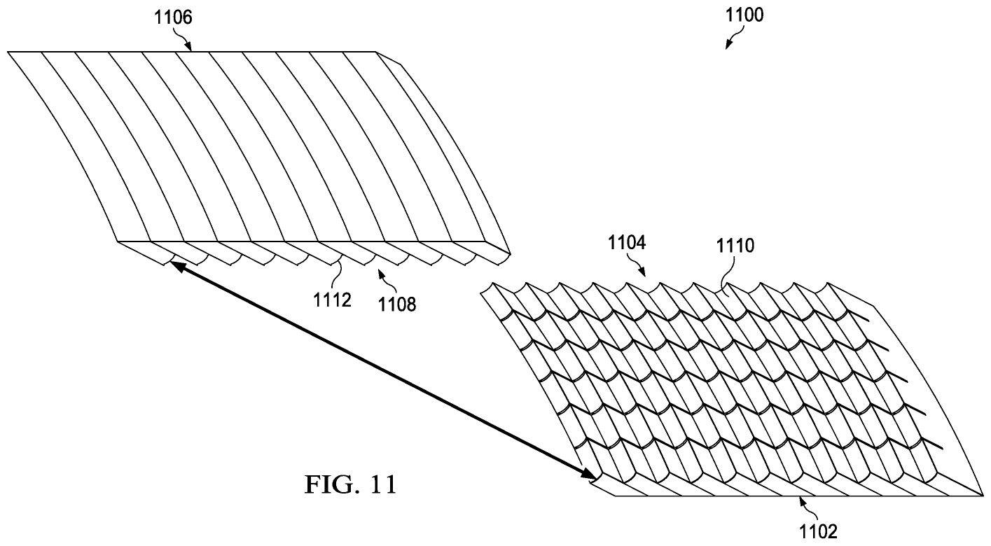

Turning now to FIG. 11, an illustration of an isometric view of an inflow compression molding tool is depicted in accordance with an illustrative example. Inflow compression molding tool 1100 may be used to form inflow cascade 108 of FIG. 1. Inflow compression molding tool 1100 may be a physical implementation of inflow compression molding tool 128 of FIG. 1. Inflow compression molding tool 1100 may be used to form inflow cascades of plurality of cascade assemblies 208 of FIGS. 2-4. Inflow compression molding tool 1100 may be used to form inflow cascade 602 of FIGS. 6-8. In some illustrative examples, inflow compression molding tool 1100 is the same as inflow compression molding tool 902 of FIG. 9.

Inflow compression molding tool 1100 comprises first die 1102 with first plurality of protrusions 1104 and second die 1106 with second plurality of protrusions 1108. As depicted, first plurality of protrusions 1104 have concave surfaces 1110. As depicted, second plurality of protrusions 1108 have convex surfaces 1112. Composite molding compound (not depicted) formed between concave surfaces 1110 and convex surfaces 1112 creates inflow vanes for an inflow cascade.

Inflow compression molding tool 1100 may be used to form an inflow cascade without any additional internal dies. For example, inflow compression molding tool 1100 may be used to form an inflow cascade without any dissolvable components.

The different components shown in FIGS. 2-11 may be combined with components in FIG. 1, used with components in FIG. 1, or a combination of the two. Additionally, some of the components in FIGS. 2-11 may be illustrative examples of how components shown in block form in FIG. 1 may be implemented as physical structures.

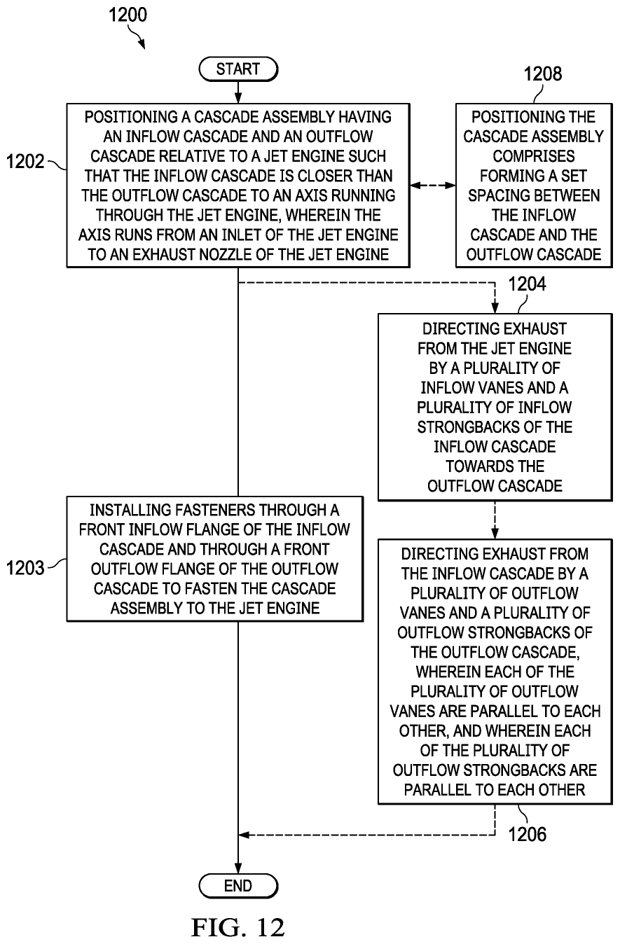

Turning now to FIG. 12, an illustration of a flowchart of a method for using a cascade assembly is depicted in accordance with an illustrative example. Method 1200 may be performed using cascade assembly 102 of FIG. 1. Method 1200 may be performed to install plurality of cascade assemblies 208 to jet engine 200 of FIGS. 2-4. Method 1200 may be used to install cascade assembly 500 of FIG. 5. Method 1200 may be used to install cascade assembly 600 of FIGS. 6-8.

Method 1200 positions a cascade assembly having an inflow cascade and an outflow cascade relative to a jet engine such that the inflow cascade is closer than the outflow cascade to an axis running through the jet engine, wherein the axis runs from an inlet of the jet engine to an exhaust nozzle of the jet engine (operation 1202). Fasteners are installed through a respective front inflow flange of each respective inflow cascade and through a respective front outflow flange of each respective outflow cascade to fasten the respective cascade assembly of the plurality of cascade assemblies to the jet engine (operation 1203). Afterwards, method 1200 terminates. In some illustrative examples, the inflow cascade is a first unitary composite structure, and the outflow cascade is a second unitary composite structure.

In some illustrative examples, method 1200 directs exhaust from the jet engine via a plurality of inflow vanes and a plurality of inflow strongbacks of the inflow cascade towards the outflow cascade (operation 1204). In some illustrative examples, method 1200 directs exhaust from the inflow cascade via a plurality of outflow vanes and a plurality of outflow strongbacks of the outflow cascade, wherein each of the plurality of outflow vanes are parallel to each other, and wherein each of the plurality of outflow strongbacks are parallel to each other (operation 1206).

In some illustrative examples, positioning the cascade assembly comprises forming a set spacing between the inflow cascade and the outflow cascade (operation 1208). In some illustrative examples, the set spacing is up to one inch.

In some illustrative examples, the cascade assembly is a first cascade assembly of a plurality of cascade assemblies. In some of these illustrative examples, method 1200 further comprises positioning the plurality of cascade assemblies relative to the jet engine, each cascade assembly of the plurality of cascade assemblies having a respective inflow cascade and a respective outflow cascade, wherein each inflow cascade of the plurality of cascade assemblies has a same design as the inflow cascade of the first cascade assembly; and installing fasteners through a respective front inflow flange of each respective inflow cascade and through a respective front outflow flange of each respective outflow cascade to fasten the respective cascade assembly of the plurality of cascade assemblies to the jet engine.

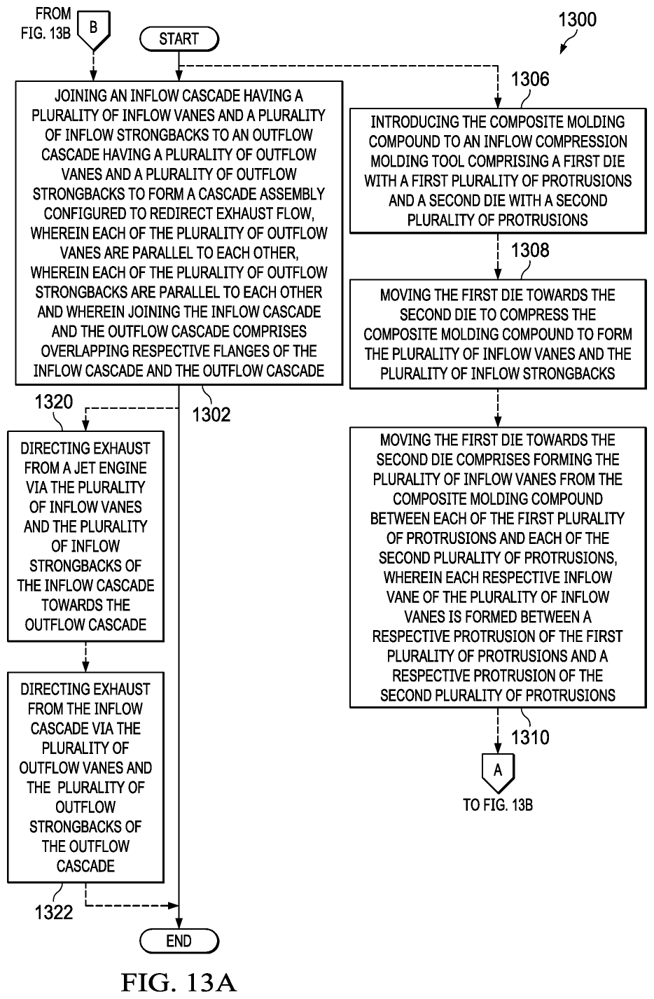

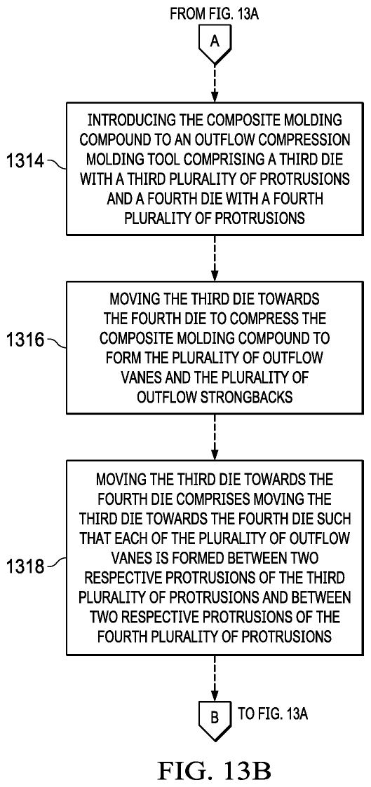

Turning now to FIGS. 13A-13B, an illustration of a flowchart of a method for forming a cascade assembly is depicted in accordance with an illustrative example. Cascade assembly 102 may be formed using method 1300 of FIGS. 13A-13B. Method 1300 may be used to form plurality of cascade assemblies 208 of FIGS. 2-4. Method 1300 may be used to form cascade assembly 500 of FIG. 5. Method 1300 may be used to form cascade assembly 600 as shown assembled in FIGS. 7 and 8. Method 1300 joins an inflow cascade having a plurality of inflow vanes and a plurality of inflow strongbacks to an outflow cascade having a plurality of outflow vanes and a plurality of outflow strongbacks to form a cascade assembly configured to redirect exhaust flow, wherein each of the plurality of outflow vanes are parallel to each other, wherein each of the plurality of outflow strongbacks are parallel to each other, and wherein joining the inflow cascade and the outflow cascade comprises overlapping respective flanges of the inflow cascade and the outflow cascade (operation 1302). Afterwards, method 1300 terminates. In some illustrative examples, joining further comprises installing fasteners through the respective flanges of the inflow cascade and the outflow cascade, wherein the respective flanges comprise a back inflow flange of the inflow cascade and through a back outflow flange of the outflow cascade.

In some illustrative examples, method 1300 further comprises compression molding a composite molding compound to form the inflow cascade. In some illustrative examples, compression molding the composite molding compound to form the inflow cascade comprises introducing the composite molding compound to an inflow compression molding tool comprising a first die with a first plurality of protrusions and a second die with a second plurality of protrusions (operation 1306) and moving the first die towards the second die to compress the composite molding compound to form the plurality of inflow vanes and the plurality of inflow strongbacks (operation 1308). In some illustrative examples, moving the first die towards the second die comprises forming the plurality of inflow vanes from the composite molding compound between each of the first plurality of protrusions and each of the second plurality of protrusions, wherein each respective inflow vane of the plurality of inflow vanes is formed between a respective protrusion of the first plurality of protrusions and a respective protrusion of the second plurality of protrusions (operation 1310).

In some illustrative examples, method 1300 further comprises compression molding the composite molding compound to form the outflow cascade. In some illustrative examples, compression molding the composite molding compound to form the outflow cascade comprises introducing the composite molding compound to an outflow compression molding tool comprising a third die with a third plurality of protrusions and a fourth die with a fourth plurality of protrusions (operation 1314) and moving the third die towards the fourth die to compress the composite molding compound to form the plurality of outflow vanes and the plurality of outflow strongbacks (operation 1316). In some illustrative examples, moving the third die towards the fourth die comprises moving the third die towards the fourth die such that each of the plurality of outflow vanes is formed between two respective protrusions of the third plurality of protrusions and between two respective protrusions of the fourth plurality of protrusions (operation 1318).

In some illustrative examples, method 1300 directs exhaust from a jet engine via the plurality of inflow vanes and the plurality of inflow strongbacks of the inflow cascade towards the outflow cascade (operation 1320). In some illustrative examples, method 1300 directs exhaust from the inflow cascade via the plurality of outflow vanes and the plurality of outflow strongbacks of the outflow cascade (operation 1322).

The flowcharts and block diagrams in the different depicted examples illustrate the architecture, functionality, and operation of some possible implementations of apparatus and methods in an illustrative example. In this regard, each block in the flowcharts or block diagrams may represent a module, a segment, a function, and/or a portion of an operation or step.

In some alternative implementations of an illustrative example, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added, in addition to the illustrated blocks, in a flowchart or block diagram.

In some illustrative examples, not all blocks of method 1200 or method 1300 are performed. For example, operations 1204 through 1208 of FIG. 12 are optional. As another example, operations 1304 through 1322 of FIG. 13 are optional.

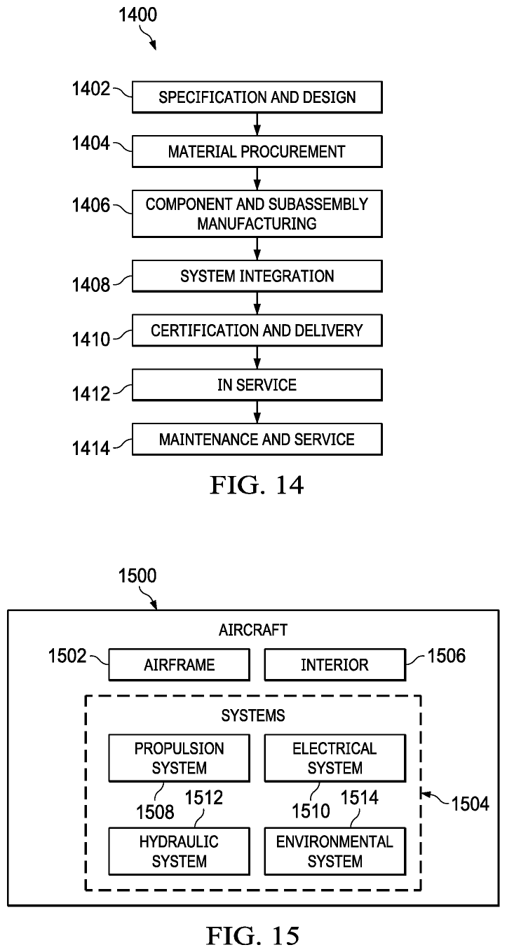

The illustrative examples of the present disclosure may be described in the context of aircraft manufacturing and service method 1400 as shown in FIG. 14 and aircraft 1500 as shown in FIG. 15. Turning first to FIG. 14, an illustration of an aircraft manufacturing and service method is depicted in accordance with an illustrative example. During pre-production, aircraft manufacturing and service method 1400 may include specification and design 1402 of aircraft 1500 in FIG. 15 and material procurement 1404.

During production, component and subassembly manufacturing 1406 and system integration 1408 of aircraft 1500 takes place. Thereafter, aircraft 1500 may go through certification and delivery 1410 in order to be placed in service 1412. While in service 1412 by a customer, aircraft 1500 is scheduled for maintenance and service 1414, which may include modification, reconfiguration, refurbishment, and other maintenance or service.

Each of the processes of aircraft manufacturing and service method 1400 may be performed or carried out by a system integrator, a third party, and/or an operator. In these examples, the operator may be a customer. For the purposes of this description, a system integrator may include, without limitation, any number of aircraft manufacturers or major-system subcontractors; a third party may include, without limitation, any number of vendors, subcontractors, or suppliers; and an operator may be an airline, a leasing company, a military entity, a service organization, and so on.

With reference now to FIG. 15, an illustration of an aircraft is depicted in which an illustrative example may be implemented. In this example, aircraft 1500 is produced by aircraft manufacturing and service method 1400 in FIG. 14 and may include airframe 1502 with a plurality of systems 1504 and interior 1506. Examples of systems 1504 include one or more of propulsion system 1508, electrical system 1510, hydraulic system 1512, and environmental system 1514. Any number of other systems may be included. Although an aerospace example is shown, different illustrative examples may be applied to other industries, such as the automotive industry.

Apparatuses and methods embodied herein may be employed during at least one of the stages of aircraft manufacturing and service method 1400. One or more illustrative examples may be used during component and subassembly manufacturing 1406, system integration 1408, or maintenance and service 1414 of FIG. 14. For example, inflow compression molding tool 128 and outflow compression molding tool 150 may be used to form cascade assembly 102 of aircraft 1500, during component and subassembly manufacturing 1406. As another example, cascade assembly 102 may be a replacement part used to replace a pre-existing cascade assembly during maintenance and service 1414 of FIG. 14.

The illustrative examples present a new design for a cascade assembly comprising an inner cascade and an outer cascade. Creating a cascade assembly having two separate cascades enables use of a compression molding process with thermoplastic material. The compression molding process is more efficient than conventional cascade manufacturing. The compression molding process uses less labor than conventional cascade manufacturing for metal or composite cascades. The compression molding process uses less time than conventional cascade manufacturing for metal or composite cascades. The simpler geometry of the presented cascade assemblies will reduce mold complexity and the related cost.

The cascade assembly is formed by combining the two cascades, the inflow cascade and the outflow cascade, which were molded separately. In some illustrative examples, when the inflow and outflow cascades are joined, a finite space is maintained between them. Combining two separate cascades in this manner simplifies the geometry of each cascade and enables use of a much simpler mold. The simpler mold reduces production time and cost while maintaining strength, structure integrity, and performance of the cascade assembly in the thrust reverser within acceptable levels.

The cascade assembly of the illustrative examples comprises a separated inflow cascade and outflow cascade. By presenting two cascades, both cascade pieces have simplified geometry. By presenting a cascade assembly with an inner cascade and an outer cascade, the vanes and strongbacks for each of the inner cascade and the outer cascade would have only straight, parallel surfaces on the outer part and either straight or much simplified geometry on the inner part. The simplified geometry in the inflow cascade and the outflow cascade of the cascade assembly enables compression molding using simple molds with as little as two parts. The simplified molds will result in cost savings from a reduction in production time associated with mold management and setup.

The description of the different illustrative examples has been presented for purposes of illustration and description, and is not intended to be exhaustive or limited to the examples in the form disclosed. Many modifications and variations will be apparent to those of ordinary skill in the art. Further, different illustrative examples may provide different features as compared to other illustrative examples. The example or examples selected are chosen and described in order to best explain the principles of the examples, the practical application, and to enable others of ordinary skill in the art to understand the disclosure for various examples with various modifications as are suited to the particular use contemplated.

What is claimed is:

1. A cascade assembly for a jet engine thrust reverser, the cascade assembly comprising:
an inflow cascade having a plurality of inflow vanes, a plurality of inflow strongbacks, and a front inflow flange;
an outflow cascade having a plurality of outflow vanes, a plurality of outflow strongbacks, and a front outflow flange, wherein each of the plurality of outflow strongbacks are parallel to each other; and
fasteners extending through the front inflow flange and the front outflow flange.

2. The cascade assembly of claim 1, wherein the inflow cascade and the outflow cascade are separated by a set spacing.

3. The cascade assembly of claim 2, wherein the set spacing is up to one inch.

4. The cascade assembly of claim 1, wherein the outflow cascade comprises a partial blanking plate.

5. The cascade assembly of claim 1, wherein each of the plurality of inflow strongbacks are parallel to each other.

6. The cascade assembly of claim 1, wherein the inflow cascade is a first unitary composite structure and wherein the outflow cascade is a second unitary composite structure.

7. The cascade assembly of claim 1, wherein each of the plurality of inflow vanes are curved, and wherein each of the plurality of outflow vanes are planar.

8. The cascade assembly of claim 1, wherein each of the plurality of outflow vanes are parallel to each other.

9. The cascade assembly of claim 1, wherein the cascade assembly is one of a plurality of cascade assemblies, and wherein each cascade assembly of the plurality of cascade assemblies has a same inflow cascade design.

10. A method comprising:
positioning a cascade assembly having an inflow cascade and an outflow cascade relative to a jet engine such that the inflow cascade is closer than the outflow cascade to an axis running through the jet engine, wherein the axis runs from an inlet of the jet engine to an exhaust nozzle of the jet engine; and
installing fasteners through a front inflow flange of the inflow cascade and through a front outflow flange of the outflow cascade to fasten the cascade assembly to the jet engine.

11. The method of claim 10 further comprising:
directing exhaust from the jet engine via a plurality of inflow vanes and a plurality of inflow strongbacks of the inflow cascade towards the outflow cascade; and
directing exhaust from the inflow cascade via a plurality of outflow vanes and a plurality of outflow strongbacks of the outflow cascade, wherein each of the plurality of outflow vanes are parallel to each other, and wherein each of the plurality of outflow strongbacks are parallel to each other.

12. The method of claim 10, wherein positioning the cascade assembly comprises forming a set spacing between the inflow cascade and the outflow cascade.

13. The method of claim 10, wherein the inflow cascade is a first unitary composite structure, and wherein the outflow cascade is a second unitary composite structure.

14. The method of claim 10, wherein the cascade assembly is a first cascade assembly of a plurality of cascade assemblies, the method further comprising:
positioning the plurality of cascade assemblies relative to the jet engine, each cascade assembly of the plurality of cascade assemblies having a respective inflow cascade and a respective outflow cascade, wherein each inflow cascade of the plurality of cascade assemblies has a same design as the inflow cascade of the first cascade assembly; and
installing fasteners through a respective front inflow flange of each respective inflow cascade and through a respective front outflow flange of each respective outflow cascade to fasten the respective cascade assembly of the plurality of cascade assemblies to the jet engine.

15. A method comprising:
joining an inflow cascade having a plurality of inflow vanes and a plurality of inflow strongbacks to an outflow cascade having a plurality of outflow vanes and a plurality of outflow strongbacks to form a cascade assembly configured to redirect exhaust flow, wherein each of the plurality of outflow strongbacks are parallel to each other, and wherein joining the inflow cascade and the outflow cascade comprises overlapping respective flanges of the inflow cascade and the outflow cascade.

16. The method of claim 15, wherein joining further comprises installing fasteners through the respective flanges of the inflow cascade and the outflow cascade, wherein the respective flanges comprise a back inflow flange of the inflow cascade and through a back outflow flange of the outflow cascade.

17. The method of claim 15, wherein each of the plurality of outflow vanes are parallel to each other.

18. The method of claim 15, further comprising:
compression molding a composite molding compound to form the inflow cascade, wherein compression molding the composite molding compound to form the inflow cascade comprises introducing the composite molding compound to an inflow compression molding tool comprising a first die with a first plurality of protrusions and a second die with a second plurality of protrusions, and moving the first die towards the second die to compress the composite molding compound to form the plurality of inflow vanes and the plurality of inflow strongbacks, wherein moving the first die towards the second die comprises forming the plurality of inflow vanes from the composite molding compound between each of the first plurality of protrusions and each of the second plurality of protrusions, wherein each respective inflow vane of the plurality of inflow vanes is formed between a respective protrusion of the first plurality of protrusions and a respective protrusion of the second plurality of protrusions.

19. The method of claim 15 further comprising:
compression molding a composite molding compound to form the outflow cascade, wherein compression molding the composite molding compound to form the outflow cascade comprises introducing the composite molding compound to an outflow compression molding tool comprising a third die with a third plurality of protrusions and a fourth die with a fourth plurality of protrusions; and moving the third die towards the fourth die to compress the composite molding compound to form the plurality of outflow vanes and the plurality of outflow strongbacks, wherein moving the third die towards the fourth die comprises moving the third die towards the fourth die such that each of the plurality of outflow vanes is formed between two respective protrusions of the third plurality of protrusions and between two respective protrusions of the fourth plurality of protrusions.

20. The method of claim 15 further comprising:
directing exhaust from a jet engine via the plurality of inflow vanes and the plurality of inflow strongbacks of the inflow cascade towards the outflow cascade; and
directing exhaust from the inflow cascade via the plurality of outflow vanes and the plurality of outflow strongbacks of the outflow cascade.
